(19) United States
(12) Patent Application Publication
(10) Pub. No.: US 2005/0162435 A1
(43) Pub. Date: Jul. 28, 2005

(54) Image rendering with multi-level Z-buffers

(75) Inventors: Kazuyuki Hashimoto, Mountain View, CA (US); Jeffrey A. Litz, San Mateo, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Electronic Arts Inc., Redwood City, CA (US)

(21) Appl. No.: 10/921,075

(22) Filed: Aug. 17, 2004

Related U.S. Application Data
(60) Provisional application No. 60/538,997, filed on Jan. 22, 2004.

(51) Int. Cl. G06F 13/00; G09G 5/02; G06T 15/40; G09G 5/36

(52) U.S. Cl. 345/545; 345/536

(57) ABSTRACT

In an image processor, images are rendered into a plurality of frame buffers and corresponding Z-buffers by depth and the plurality of frame buffers are later combined to form the rendered image. The rendering can be implemented in hardware, software or a combination, for real-time or near real-time rendering of images. The plurality of frame buffers can be processed in parallel using a plurality of frame processors. The rendering can be performed on a stream of polygons received in an arbitrary order so that presorting the polygons is not required. Complex data structures and processing are not required, allowing a rendering process to proceed quickly, which is needed where the rendering must be done in real-time or near real-time for full- or nearly full-motion video. The image processor is provided with an indication of the number of frame buffers in the plurality of frame buffers. With this indication, the image processor can make the program memory allocations if needed and will process the image data with the required fidelity. The number of frame buffers used might vary as needed for different fidelities and images.

### CROSS-REFERENCE TO RELATED APPLICATIONS

This application claims priority from co-pending U.S. provisional patent application No. 60/538,997 filed Jan. 22, 2004 entitled “Image Rendering with Multi-Level Z-Buffers”, which is hereby incorporated by reference, as if set forth in full in this document, for all purposes.

### FIELD OF THE INVENTION

The present invention relates generally to image rendering and in particular to efficiently rendering an image from a geometric model of a plurality of objects using buffering.

### BACKGROUND OF THE INVENTION

Computer generated images are often created by examining a geometric model of a view space and modeled objects in the view space. The geometric model of the objects can have arbitrary resolution, but typically each object is represented by a finite number of polygons, such as triangles, positioned in the view space and having a color, color pattern or texture over their surface, and an alpha value or values representing transparency of the polygon. An image is typically output (stored, displayed, transmitted, or otherwise processed) as a pixel array.

A computer generated image can be represented by an N-dimensional array of pixel color values, or tuples, wherein each item in a tuple corresponds to a color channel. For example, a two-dimensional color image might be represented by a two-dimensional array of pixels, where each pixel is assigned a pixel color according to a red-green-blue (RGB) triple, and where each component of the triple is represented by a finite value. Other color spaces might be used, but generally an image is representable by each pixel having a pixel color selected from a color space. Sometimes, these components are referred to as channels, e.g., the red channel, the green channel, the blue channel and the alpha channel. The alpha channel might not be used, such as where the red, green and blue channels fully specify the color to be used and the image is not going to be overlaid on other image components that would show through.

The process of generating a pixel array of color values from a geometric model is often referred to as “rendering” an image. In a rendered image, the color value of a given pixel is, ideally, the color of light that would be received through a corresponding opening in a grid placed in a view plane relative to a view point. FIG. 1 illustrates a geometric model. In that example, two triangles, A and B, have positions in a view space 10. An image is rendered from a view point 12 through a grid 14 having grid openings corresponding to the pixels of the final image's pixel array. In the image, each pixel's color should correspond with the color contributions of zero, one or both of the triangles, and/or the background for the contributions through the pixel's corresponding grid opening. To perform this step, it should be known which portions of which objects appear within that grid opening and the object's color(s), transparency and depth (distance from view point 12, which is important because where an object is fully obscured by a closer object, the farther object's color does not affect the pixel's color).

One approach to rendering is ray tracing, wherein a computer system or process that is performing the rendering “follows” a ray from the view point through a grid opening in the view plane corresponding to the pixel being rendered and determines which polygons are intersected by the ray. At each intersection until the ray intersects an opaque polygon, the computer calculates the effects of the intersected polygon on the color of light that would be received at the view point through that grid opening.

Ray tracing generates realistic images but requires considerable processing. For example, as the computer scans a table of polygons, it must find locations for each polygon to determine whether it intersects with the current ray. While ray tracing is useful, it is not practical in many applications, such as those that require real-time rendering.

Real-time rendering, as used herein, refers to rendering where the computer obtains the geometric model and must output the rendered image a short time after the model is received. As an example, a computer generated movie need not be generated in real-time because the geometric model would be available once the editors decide on a final cut and rendering can proceed for weeks or months. However, with an interactive video game, the geometric model might depend on actions of a game player that are not determinable in advance and the computer must render the scene in very little time in order for the game to feel responsive to the player's actions.

For real-time rendering, a common approach is the Z-buffer approach. With Z-buffering, a geometric model of an image is input to a renderer. The renderer maintains a frame buffer and a Z-buffer (also referred to as a “depth buffer”). The frame buffer might be a two-dimensional array of a size comparable to the final image size, with each cell of the array having several components. For example, where a renderer is to generate a 24-bit color 1024×768 pixel image, the frame buffer might comprise a 1024×768 array with each cell of the array having storage for a red value, a green value, a blue value and an alpha value.

When the image is completely rendered, the red/green/blue values can be used to form the image and the alpha values can be used where the frame buffer is combined with another image or frame buffer. In effect, a cell's values indicate the color for the corresponding pixel and the transparency of the image at that pixel, which is useful for determining ultimate color values when the frame buffer contents are “overlaid” on a background or another image or frame buffer.

In using the frame buffer, the renderer receives information about polygons as a stream of polygons or otherwise reads them according to some sequence. In many cases, the order of polygons in the stream is such that a nearer polygon is received before a farther polygon is received and, where polygons intersect, it might be that polygons could not be strictly ordered by depth. A current polygon from the stream is processed and then a next polygon is processed, or more than one can be done in parallel. The current polygon is processed by examining its parameters to determine which pixels the current polygon spans, based on the position of the polygon in the view space, the view point and the view plane grid. For each pixel spanned by the polygon, the corresponding value in the frame buffer is set to the color of the portion of the polygon that overlaps that pixel, as illustrated in FIG. 2.

In FIG. 2, a frame buffer 20 is shown populated with results of processing triangles A and B. One of the frame buffer cells, cell 22, is shown expanded and comprises three color values (red, green, blue) 24 and a transparency value (alpha) 26.

As shown in FIG. 2, the values for most pixels in the frame buffer are blank (or set to a background color, pattern or texture), and some of the cells contain values for one or more objects. Values for more than one object occur, for example, where objects overlap and the closer object has at least some transparency or where an object does not fully cover the pixel's grid opening (typically, but not necessarily, a pixel's grid opening is a square or rectangular grid opening).

Of course, the renderer will have to deal with overlaps of polygons and interaction of a transparent or partially transparent polygon and the background. For this, the Z-buffer comes into play. As illustrated in FIG. 3, a Z-buffer 30, also typically of comparable size as the image, has cells 32 representing a depth value for the polygon that is represented by the corresponding color value in the frame buffer. The Z-buffer is used to determine if the individual rasterized pixels of a newly received polygon need to be considered.

As the renderer receives polygons, it determines the Z value (depth) of the polygon at each pixel that it spans, as illustrated in FIG. 3. In some implementations, pixels with full or partial coverage are updated except where the pixel is on a right and/or bottom edge of a triangle (or some other method is used to ensure that pixels along a shared edge or between two polygons can avoid being updated more than once).

These Z values are stored in the Z-buffer if the depth is less than any prior Z value stored there. Alternatively, some other criterion might be used other than “less than”. In a typical implementation, only one Z value is stored for the Z-buffer, so a full history of what polygons intersect a pixel is not available.

At the outset, each cell of the frame buffer is zeroed or set to a background color, pattern or texture, and each cell of the Z-buffer is set to a background value, such as infinity. Then, when the renderer receives the model for the first polygon, the renderer stores its color values into the corresponding pixel cells of the frame buffer and its depth at each pixel in the Z-buffer. Where the polygon is transparent or partially transparent, the background values would be taken into account in assigning the frame buffer cell values.

For the next polygon, it if does not overlap the first polygon, the same processing is done. However, where the second polygon (or any subsequent polygon) is in front of the first polygon (or any previous polygon), the Z-buffer is updated with the new closer depth value for the new polygon and the frame buffer is updated with a new value reflecting the current polygon's color values, the current polygon's transparency (alpha value) and the current values in the frame buffer at the overlapping pixel locations.

If a later polygon is behind an earlier polygon (i.e., at a farther depth), it is not processed. It cannot be processed properly if all that is available is a frame buffer and a Z-buffer, because there is not enough information about what is in front of that later polygon and how the current frame buffer values were determined. One could search over all received polygons to seek out the overlapping polygons, but this is a computationally expensive operation and cannot usually be done in the limited time allotted to rendering in real-time.

One solution is to ignore the overlaps and assume that polygons are for the most part well-shaped and are fully opaque. This is acceptable in some images, but results in aliased edges and significant anomalies where many polygons are not fully opaque. For example, when rendering a tinted window in front of a tree in front of a building, if some of the polygons of the tree are processed after the polygons of the window, the image will show the building though the window with invisible leaves on the tree.

The problem can be resolved by sorting all polygons by depth before sending them to the renderer. In the example above, the renderer would receive all of the polygons for the building and update the frame buffer accordingly, then the polygons for the tree and then the polygons for the window, so that each polygon were processed. While this might work in theory, in practice this is difficult to do, because sorting takes considerable computing time, especially for a typical model of 10,000 polygons or more, and cannot deal with the problem of intersecting polygons, where a first polygon and a second polygon overlap as projected onto the view space, where for some pixels the first polygon is closer to the view point than the second polygon and for some other pixels the second polygon is closer to the view point than the first polygon. Intersecting polygons might be dealt with by sorting the polygons differently for each pixel, but the computation required for that would be prohibitive.

Another approach is the use of depth bins. That approach, polygons are not fully sorted by depth, but are allocated to bins associated with depth ranges. Once all of the polygons are “binned”, the bin with the lowest depth range that contains polygons is processed. This approach has the disadvantages of requiring storage for polygons, guessing the appropriate depth ranges correctly on the first pass, and being unable to deal with polygons that are in different bins but still intersect or with polygons that fall into multiple bins.

In another approach, a variation on the Z-buffer known as the A-buffer is used. In an A-buffer, each pixel is represented by an entry in a pixel buffer array which indicates the color and depth of the surface taking up that pixel or a linked list of surfaces that might take up all or part of the pixel's area when one surface is transparent or does not cover the entire pixel area. While the A-buffer approach can be used to generate a perfect image (i.e., an image that would result if each of the polygons were sorted without overlap prior to rendering), it tends to be complex and requires extra steps of managing the linked lists and the like.

An improvement in rendering would be desirable to overcome the shortcomings of the prior art described above.

### BRIEF SUMMARY OF THE INVENTION

In one embodiment of an image processor, images are rendered into a plurality of frame buffers and corresponding Z-buffers by depth and the plurality of frame buffers are later combined to form the rendered image. The rendering can be implemented in hardware, software or a combination, for real-time or near real-time rendering of images. The plurality of frame buffers can be processed in parallel using a plurality of frame processors.

In one aspect of the present invention, the rendering can be performed on a stream of polygons received in an arbitrary order so that presorting the polygons is not required. Complex data structures and processing are not required, allowing a rendering process to proceed quickly, which is needed where the rendering must be done in real-time or near real-time for full- or nearly full-motion video.

In one aspect of the present invention, the image processor is provided with an indication of the number of frame buffers in the plurality of frame buffers. With this indication, the image processor can make the program memory allocations, if needed, and will process the image data with the required fidelity. The number of frame buffers used might very as needed for different fidelities and images.

A further understanding of the nature and the advantages of the inventions disclosed herein may be realized by reference to the remaining portions of the specification and the attached drawings.

### BRIEF DESCRIPTION OF THE DRAWINGS

FIG. 1 illustrates an example of a conventional geometric model usable for rendering an image therefrom.

FIG. 2 illustrates an example of a conventional frame buffer.

FIG. 3 illustrates an example of a conventional Z-buffer.

FIG. 4 illustrates an overlap at varying scales.

FIG. 5 is a block diagram of a computer system usable for rendering images according to aspects of the present invention.

FIG. 6 is a block diagram illustrating processor and buffer interaction.

FIG. 7 illustrates errors that occur when polygons are processed in an unsorted order with a conventional frame buffer; FIG. 7A illustrates a process wherein polygon contributions to a pixel are processed front to back, whereas FIG. 7B illustrates a process wherein polygon contributions to a pixel are processed back to front.

FIG. 8 illustrates what happens when polygons are processed in an unsorted order where a multilevel Z-buffer is used; FIG. 8A illustrates processing front to back, whereas FIG. 8B illustrates processing back to front.

FIG. 9 illustrates an example of a buffer and allocations of pixels to specific buffers.

FIG. 10 shows an example of a state of multilevel frame buffers and multilevel Z buffers after processing two polygons that overlap.

FIG. 11 is a flowchart of one possible process for processing a rasterized pixel of a polygon in a renderer.

FIG. 12 shows an example set of elements to be processed using multilevel frame buffers and multilevel Z buffers according to embodiments of the present invention.

FIG. 13 illustrates a process for rendering the elements shown in FIG. 12 in an arbitrary order.

FIG. 14 is a block diagram of a parallel processing system usable to parallel process polygons to render images.

FIGS. 15(a)-(f) illustrate various effects of using frame buffers.

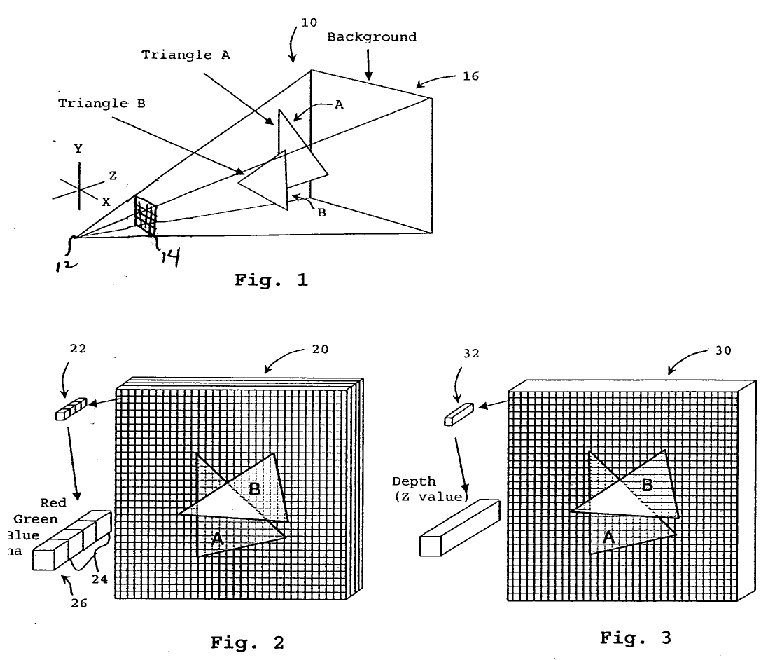

### DETAILED DESCRIPTION OF THE INVENTION

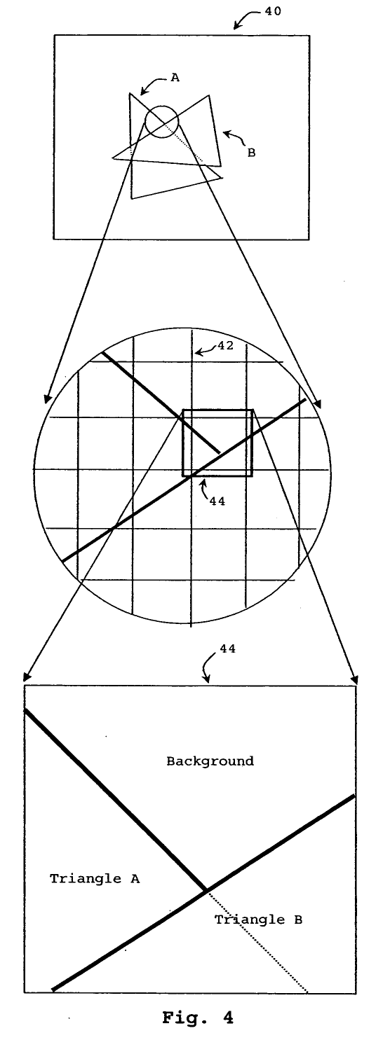

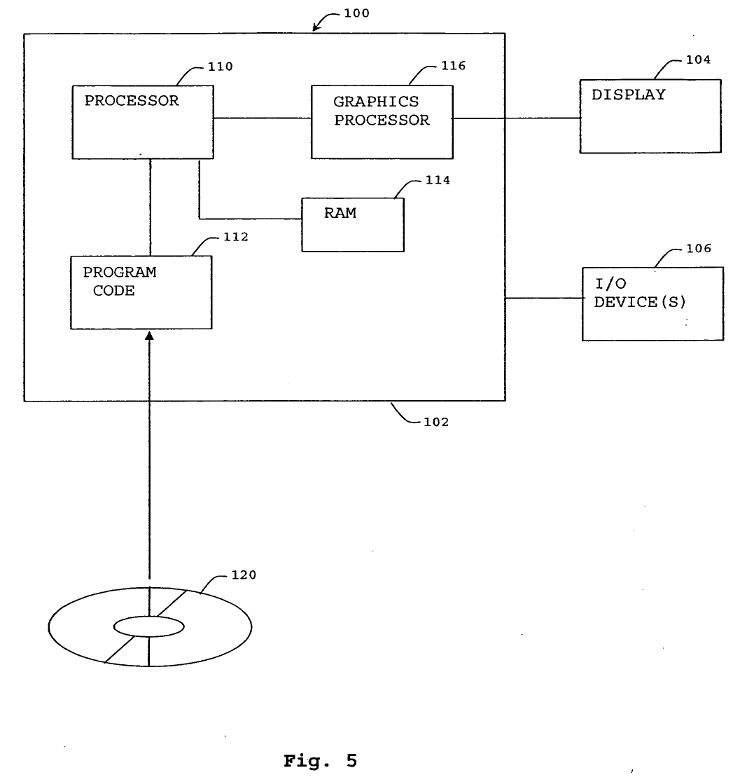

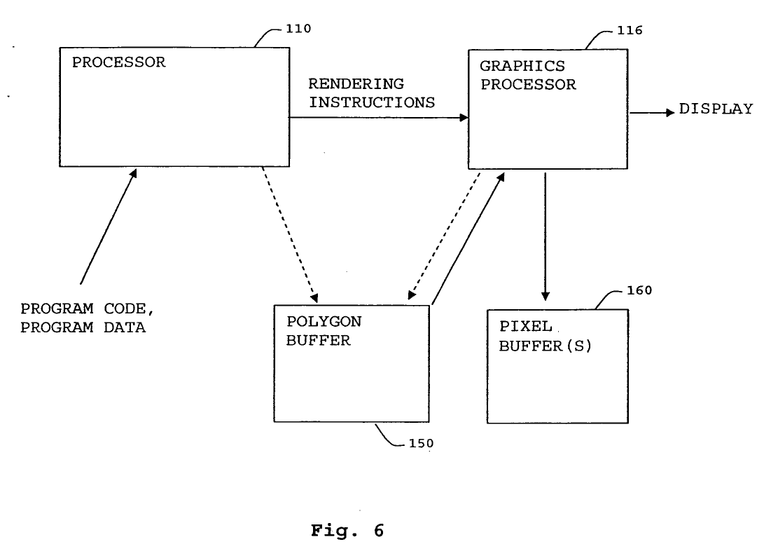

As shown in FIG. 4, when rendering elements (such as polygons), a pixel might cover more than one of those elements. In FIG. 4, a view plane 40 is what is being rendered and includes views of triangles A and B. In this case, when mapped to a pixel grid 42, one intersection of the two triangles is within the grid opening for a pixel 44. As illustrated by the zoomed-in view, pixel 44 is partially covered by triangle A, partially covered by triangle B, and partially covered by neither, so the background shows through. For ideal rendering of a color value for pixel 44, the contributions of each of those three elements should be included. This can be done by considering the relative areas of the pixel grid opening that each element occupies and the color/transparency values of each. If all of the polygons are sorted (either for the entire image or using scan strip approaches), then each element that overlaps each pixel can be considered, however for most practical processing systems of this sort, the system needs to obtain information about an element, in sequence, process it and move on to the next element. Thus, the system needs to deal with polygons as received and assume they are not sorted.

FIG. 5 is a block diagram of a video game computer system 100 usable for rendering images according to aspects of the present invention. System 100 is shown comprising a console 102 coupled to a display 104 and input/output (I/O) devices 106 usable for interacting with a game user. Console 102 is shown comprising a processor 110, program code storage 112, temporary data storage 114 and a graphics processor 116. Console 102 might be a handheld video game device, a console (special purpose) computing system for operating video games, a general-purpose laptop or desktop computer, or other suitable system.

Program code storage 112 might be ROM (read only memory), RAM (random access memory), hard disk, other magnetic storage, optical storage, other storage or a combination or variation of these. In a common arrangement, part of the program code is stored in ROM that is programmable (ROM, PROM, EPROM, EEPROM, etc.) and part of the program code is stored on removable media such as CD-ROM 120 (as shown), or might be stored on a cartridge, memory chip or the like, or obtained over a network or other electronic channel as needed. In general, program code can be found embodied in a tangible signal-bearing medium.

Temporary data storage 114 is usable to store variables and other game and processor data as needed. Typically, temporary data storage 114 is RAM and holds data that is generated during the play of the game, and portions thereof might also be reserved for frame buffers, depth buffers, polygon lists, texture storage and/or other data needed or usable for rendering images as part of a video game presentation.

Since the video game is likely to be such that the particular image sequence presented on display 104 depends on results of game instruction processing, and those game instructions likely depend, in turn, on user inputs, it is important that console 102 quickly process inputs and render a responsive image sequence.

FIG. 6 is a block diagram illustrating processor and buffer interaction, showing elements of FIG. 5 in greater detail. As shown in FIG. 6, processor 110 reads in program code and program data and, in response to program instructions, outputs rendering instructions to graphics processor 116, which, in turn, reads from a polygon buffer 150 and interacts with pixel buffer(s) 160 to form an image sequence of one or more images that are output as a display on console 102. Alternatively, instead of sending rendering instructions to graphics processor 116 or in addition to sending rendering instructions, processor 110 may directly interact with polygon buffer 150. For example processor 110 could determine which objects are to appear in a view and provide polygon or other mathematical representations of those objects to polygon buffer 150 for subsequent processing by graphics processor 116.

In one example implementation, processor 110 issues high-level graphics commands to graphics processor 116. Such high-level graphics commands might be those specified by the Open GL specification, or those specified by a graphics processor manufacturer.

In a typical image rendering process, graphics processor 116 reads polygon data from polygon buffer 150 for a polygon, processes that polygon and updates pixel buffer(s) 160 accordingly, then moves on to the next polygon until all the polygons are processed, or at least all of the polygons needing to be processed and/or in view are processed. In this sense, a renderer processes a stream of polygons, even though the polygons might be read in place and be a finite set where the number of polygons is known or determinable. For memory efficiency and speed, it is often preferable that polygons be processed as a stream (as opposed to random access, or other ordering), so that fast, expensive memory used for polygons being processed is not required for all polygons comprising an image.

Where possible, processor 110 may load polygon buffer 150 with polygon data in a sort order (if one is possible, which might not be the case where there are overlapping polygons), but more typically polygons are stored in polygon buffer 150 in an unsorted order. It should be understood that although these examples use polygons as the image elements being processed, the apparatus and methods described herein can also be used on image elements other than polygons.

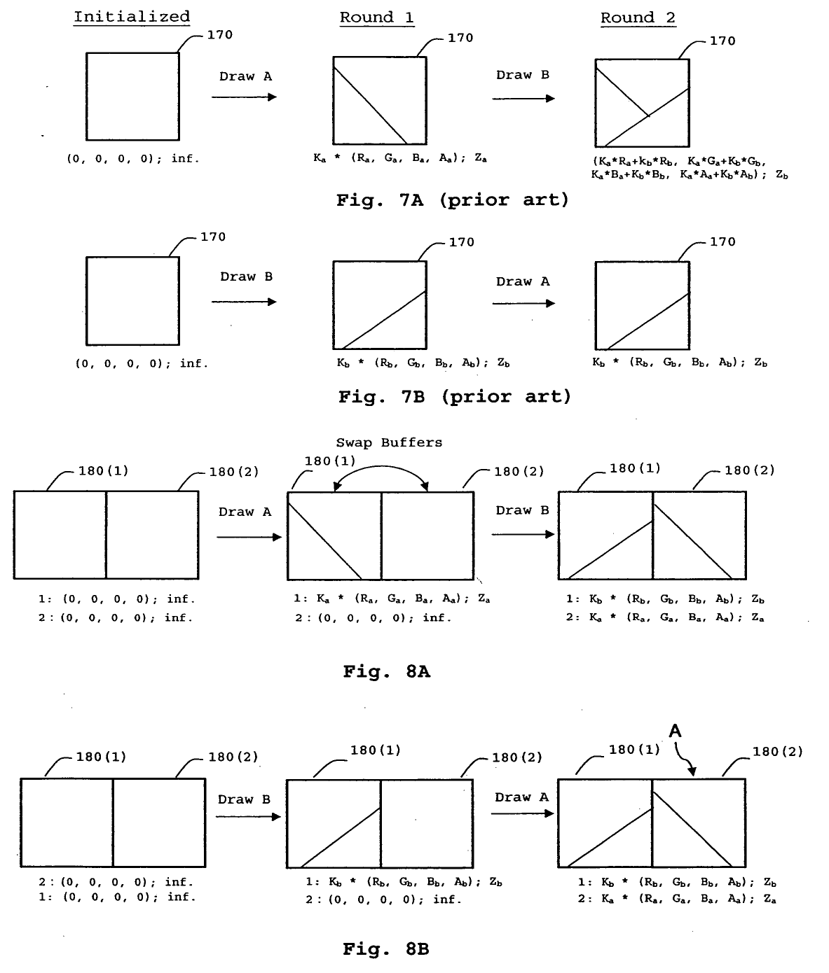

FIG. 7 illustrates how different results might be obtained depending on the order of processing elements received by a renderer, such as graphics processor 116. A frame buffer cell (and its corresponding Z-buffer cell) 170 begin at an initial value (here, zeroes for color values and a value of “infinite” for depth). Frame buffer cell 170 is typically one of many cells in a frame buffer, as might be formed with the memory storage of pixel buffer(s) 160 shown in FIG. 6 or similar storage.

In FIG. 7A, a case where triangle A is received first is considered. When the renderer receives triangle A, it updates the depth for cell 170 to Zₐ, the depth of triangle A at the corresponding pixel location and updates the color and alpha values as well to the colors/transparency of A at that location, which is shown as kₐ*(Rₐ, Gₐ, Bₐ, Aₐ), where kₐ is a constant representative of the amount of the pixel covered by A. Where color spaces other than RGB are used, corresponding values would be stored instead. For example, each contribution might be characterized by four values in the CYMK space and/or include additional components such as fog values, pixel adjustments, etc.

When the renderer receives triangle B, it checks the depth of B at the pixel corresponding to cell 170 and notes that Z_{b} is less than Zₐ, so it combines the triangle B values R_{b}, G_{b}, B_{b} and A_{b} with the values already in the frame buffer, where k_{b} is a factor to account for transparency and relative coverage of B and other conditions (such as where depth determines opacity). The resulting value for that pixel is then (kₐ*Rₐ+k_{b}*R_{b}, kₐ*Gₐ+k_{b}*G_{b}, kₐ*Bₐ+k_{b}*B_{b}, kₐ*Aₐ+k_{b}*A_{b}) with a depth value of Z_{b}.

This works if the elements are received in order from farthest to closest, which typically leads to an expectation that the renderer will receive a sorted list. However, where there is no time or computing resources to sort, or where sorting is not possible due to overlaps, the effects are not as good.

In FIG. 7B, a case where triangle B is received first is considered. When the renderer receives triangle B, it updates the depth for cell 170 to Z_{b} and updates the color and alpha values as well to the colors/transparency of B at that location, k_{b}*(R_{b}, G_{b}, B_{b}, A_{b}). However, when the renderer is presented with triangle A, it checks the depth and notes that Zₐ is greater than Z_{b} at that pixel location, so it has to ignore the contribution of triangle A. Unless much more information is retained about prior elements and the background, the renderer cannot easily determine all of the contributions that led to the current value in the frame buffer cell and work backwards to consider triangle B.

FIG. 8 illustrates an improved result using multi-level frame buffers according to aspects of the present invention. A frame buffer/Z-buffer cell 180 is shown there, with two levels, represented by cell 180(1) and cell 180(2). Again, a case where triangle A is received first is considered. When the renderer receives triangle A, it checks for contents of cells 180(1) and 180(2), noting that both are empty (or set to background values) and updates the color, alpha and depth values for cell 180(1) to kₐ*(Rₐ, Gₐ, Bₐ, Aₐ) and Zₐ.

When the renderer receives triangle B, it checks the depth and notes that Z_{b} is less than Zₐ, so it shifts the contents of cell 180(1) to cell 180(2) and uses cell 180(1) for the values k_{b}*(R_{b}, G_{b}, B_{b}, A_{b}) and Z_{b}. For subsequent elements, their depth values are considered relative to the contents of cells 180(1)-(2). If a subsequent element is closer than both A and B, the renderer would overwrite contents of cell 180(2) with contents of cell 180(1) and use cell 180(1) for the subsequent element. If a subsequent element is between A and B, the renderer would overwrite contents of cell 180(2) with the subsequent element. If a subsequent element is farther than both A and B, the renderer would ignore it, unless there were more than two levels.

In FIG. 8B, a case where triangle B is received first is considered. When the renderer receives triangle B, it updates cell 180(1) with k_{b}*(R_{b}, G_{b}, B_{b}, A_{b}) and Z_{b}. When the renderer is presented with triangle A, it checks the depth of A and notes that Zₐ is greater than Z_{b} at that pixel location, so it updates cell 180(2) with kₐ*(Rₐ, Gₐ, Bₐ, Aₐ) and Zₐ.

As an example of the additional overhead for multilevel buffers, consider a typical implementation. For a display of 640 pixels by 480 pixels, where each color component has a resolution of eight bits, alpha values have a resolution of eight bits and depth values have a resolution of 32 bits, each level of a frame buffer and depth buffer would require about 2.5 megabytes of memory, so a four-level buffer would require only around 10 megabytes of memory, which is inexpensive relative to the cost of processing power that would otherwise be needed. The number of levels might vary according to the complexity of the scene. For example, some backgrounds might require only a few frame buffers whereas hair, glass, depth and other image features might require more frame buffers. A game designer might specify, overall, per scene or per condition, how many frame buffers to use. High-level graphics commands might include a command that directs an image as to how many frame buffers to use.

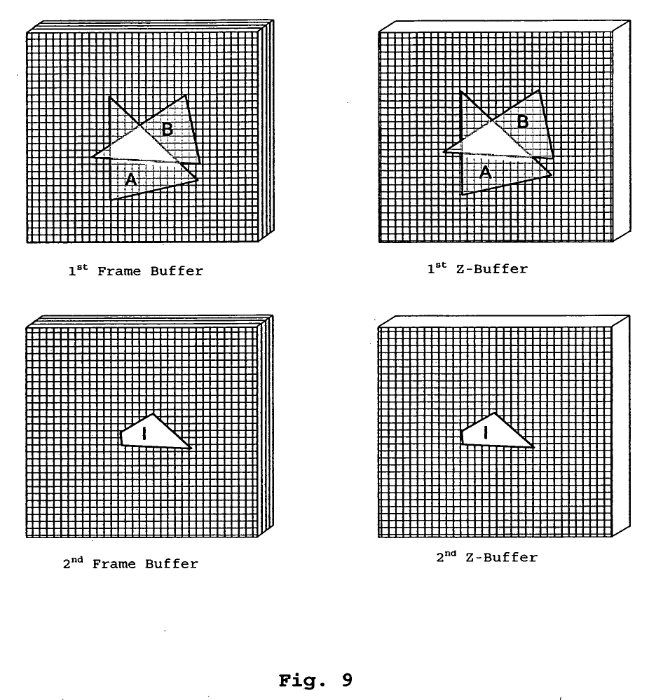

FIG. 9 illustrates the contents of the two levels of frame buffers and Z-buffers after processing triangles A and B in the example above. As illustrated, the first level of the frame buffer contains values for pixels covered by either triangle and the second level of the frame buffer contains values for pixels covered by both triangles.

Once all the elements are processed, the multilevel frame buffers can be collapsed into one buffer. Since the levels at each cell end up in depth order, the frame buffers can be processed as the background, level 2, followed by level 1. In the more general case, the levels can be processed as the background, followed by level N, level N−1, . . . , level 2, then level 1. Thus, this process forms a “partial sort”, with much less effort than a full sort and much better image quality than a “no sort” approach. In other words, the process keeps the top N>1 values for each pixel and sorts them at the end of the process (or they already end up in sorted order) to generate pixel values. In some cases, the value of N can be variable, to speed processing and reduce memory usage on simpler images with lower values of N, and improve image quality when needed with higher values of N.

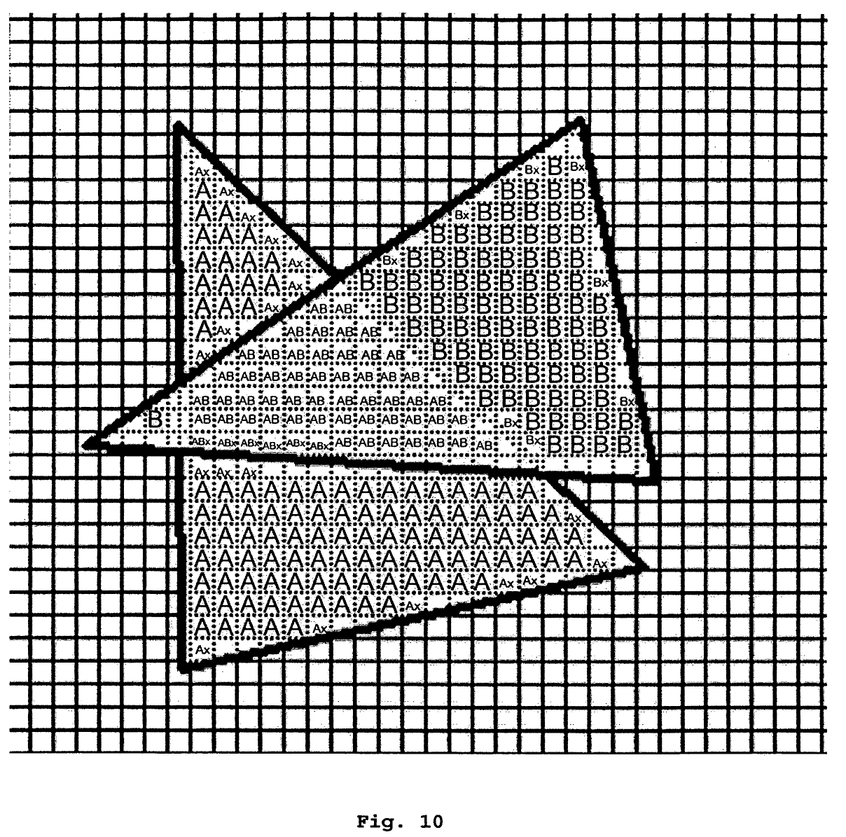

FIG. 10 shows an example of a state of multilevel frame buffers and multilevel Z buffers after processing two polygons that overlap. As illustrated there, some pixels will be colored according to values in the first level frame buffer that are from triangle A, triangle B and/or the background (“X”) while some pixels will be colored using B values from the first level frame buffer and A values from the second level frame buffer (“BA”).

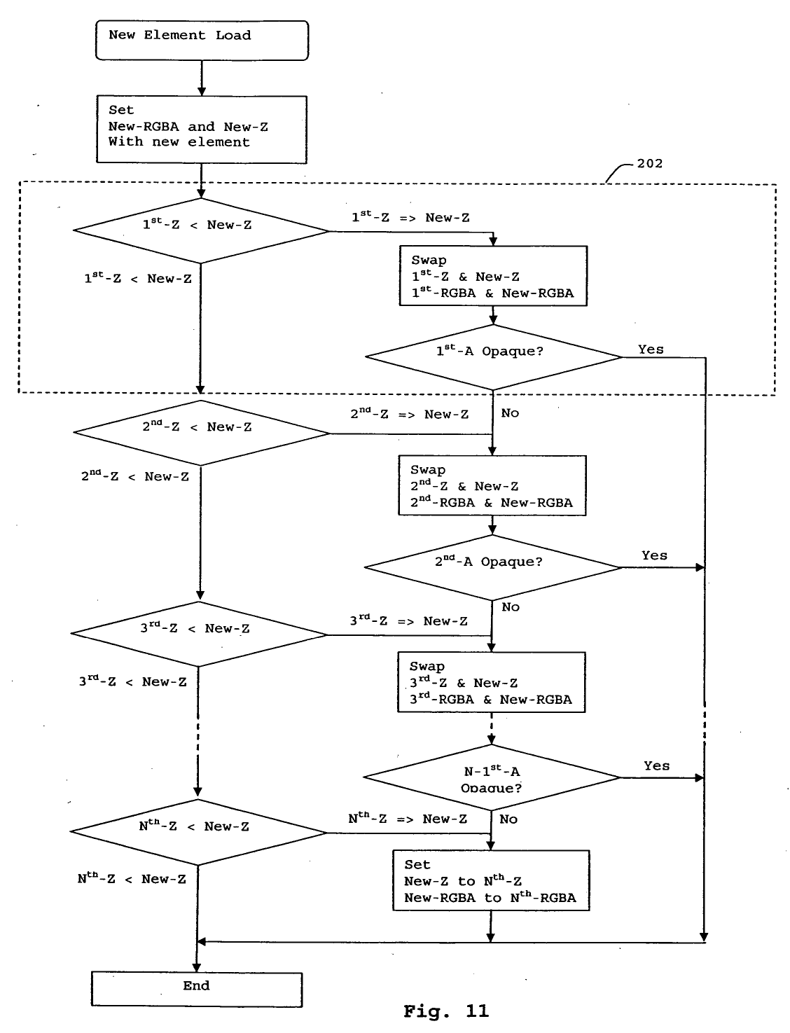

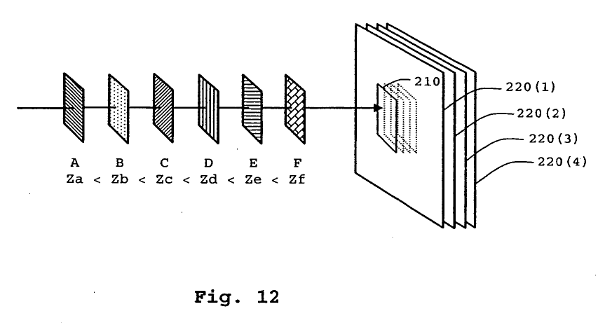

FIG. 11 is a flowchart of one possible process for processing a rasterized pixel of a polygon in a renderer. In this example, there are N levels of buffers. In practice, for some images, N=2, N=4, N=8 or N=5 has a satisfactory effect. With higher N, the gains might not be noticeable, as the effect of polygons on pixel color beyond the closest four polygons might not be much. Note that because the contribution of each element is considered in determining at what level to place its contribution, the result is that the closest N elements at each pixel are what remain in the frame buffer. In some embodiments, processing is terminated when an opaque element that fully covers the pixel is encountered, to save processing steps as elements farther away would have no effect on that pixel's color.

As illustrated there, when a new element is loaded, variables New-RGBA and New-Z are set corresponding to the color value of the new element at a given pixel location and the depth of the element at the given pixel location, respectively. The Z value is compared with the Z values already stored in various levels of the Z-buffer. When the appropriate location is found for the new element's contribution, it is swapped in at the appropriate level. If the new element is not entirely opaque and covering the given pixel entirely, then the swapped out values are swapped with the next lower level, and so on. If the new element is opaque and covers the given pixel entirely, the values for more distant levels need not be considered and further processing can be skipped, although some implementations might perform just the processing instead of the checking. The latter might be useful where the amount of computation to determine complete coverage of the pixel is more than the computation needed to swap values.

A dashed box 202 represents one stage of the new element load, checking and swapping process. In some embodiments, the code and/or logic used for the process steps of dashed box 202 is reused for each of the N stages, or however many stages are used to find the right level for the new element at that pixel location. Note that, where polygons intersect, the order of the polygons may differ from pixel to pixel, but that is dealt with automatically. While the example shown illustrates a serial approach, parallelism might be introduced such that more than one stage is considered at a time, more than one element is considered at a time, and/or more than one pixel is considered at a time.

In this example, the test for whether to consider a polygon contribution to a pixel should be considered based on Z values can be other than the “less than” tests shown in the steps in the left column of the above FIG. 10. The test of the “i-th” Z and New-Z can be the truth of one of the following expressions: IZ>New-Z, IZ<New-Z, IZ≧New-Z, IZ≦New-Z, IZ==New-Z, IZ!=New-Z (not equal), where IZ is the i-th Z. Using different comparisons on the same set of polygons may result in different visual effects.

FIG. 12 shows an example set of elements to be processed using multilevel frame buffers and multilevel Z buffers according to embodiments of the present invention. As shown there, elements A, B, C, D, E and F overlap the current pixel 210. Their depths are such that Zₐ<Z_{b}<Z_{c}<Z_{d}<Zₑ<Z_{f}. Information about these elements can be stored on a pixel-by-pixel basis for ultimate rendering to pixel component values in planes 220(1), 220(2), 220(3), and 220(4).

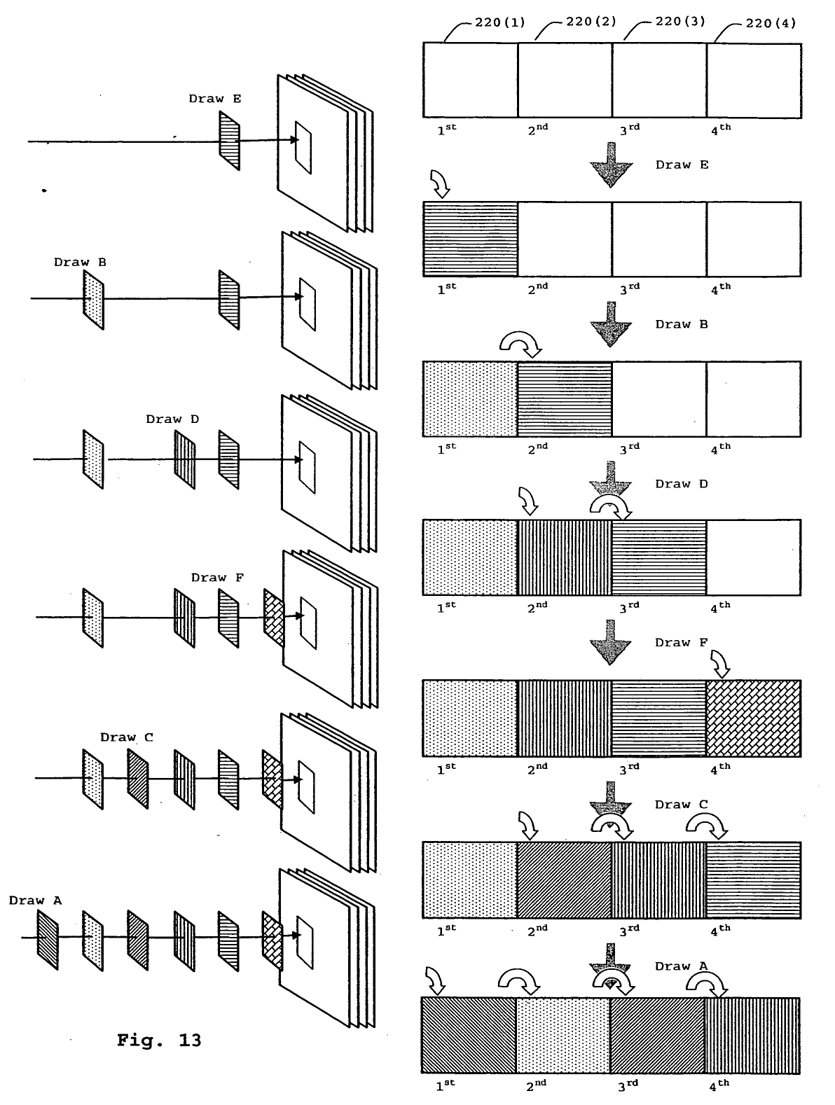

FIG. 13 illustrates a process for rendering the elements shown in FIG. 12 in an arbitrary order. Note that after the first four elements are processed, an element is dropped off, as there would then be four closer elements. In some embodiments, where four (or more) elements are detected, the background contribution is not considered, to avoid artifacts.

As illustrated by FIG. 13, first each level of the buffer is empty. Assume that elements are received in this order: E, B, D, F, C, A. The first element encountered is element E and that is drawn into cell 220(1). Then, element B is drawn into cell 220(1) and the contents of cell 220(1) are shifted to cell 220(2). This shifting can be done using a memory swap process followed by an overwrite of new contents. Next, element D is processed, with cell 220(2) shifting to cell 220(3) and element D drawn into cell 220(2). The operation proceeds until all six elements are processed, resulting in elements A, B, C and D remaining in the cells. These can then be combined for a final result.

Using these techniques, images having polygons that are not fully opaque can be dealt with. Also, cases where one pixel is spanned partially by one polygon and a background and/or more than one polygon can be dealt with, resulting in improvements for anti-aliased polygon edge, line, point and any other element that does not fully cover a pixel.

The number of frame buffers used might depend on several factors, such as the cost constraints for the added memory, the likely number of transparent polygons and the size of the polygons. Where the size of the polygons is less than the pixel span, it is likely that many pixels will find contributions from several polygons, transparent or not, so more frame buffers might be called for. In a hardware implementation, the memory use for frame buffers might be fixed at a fixed number of frame buffers, or the memory might be shared for other purposes and the number of frame buffers available might be variable. One of the frame buffers might serve as the accumulator frame buffer into which all of the other frame buffers are totaled once all of the polygons are processed.

While frame buffers and Z-buffers are shown in some examples as separate constructs, they might be a single, multifaceted data structure, such as is illustrated by the cells 180 of FIG. 8. Setting the number of levels to four works well for many applications, but other numbers of levels, such as two, three, five, eight, ten and twelve might also work for certain applications. As the relative cost of memory versus computing effort changes, it might make sense to add memory to avoid additional computing tasks.

The apparatus and methods described herein can be used in various graphics applications, such as scientific modeling, presentations, video games, and the like, where rendering is needed. For video games, an apparatus might be built into a game console, or the methods implemented in software that has access to memory for use as the multilevel buffers.

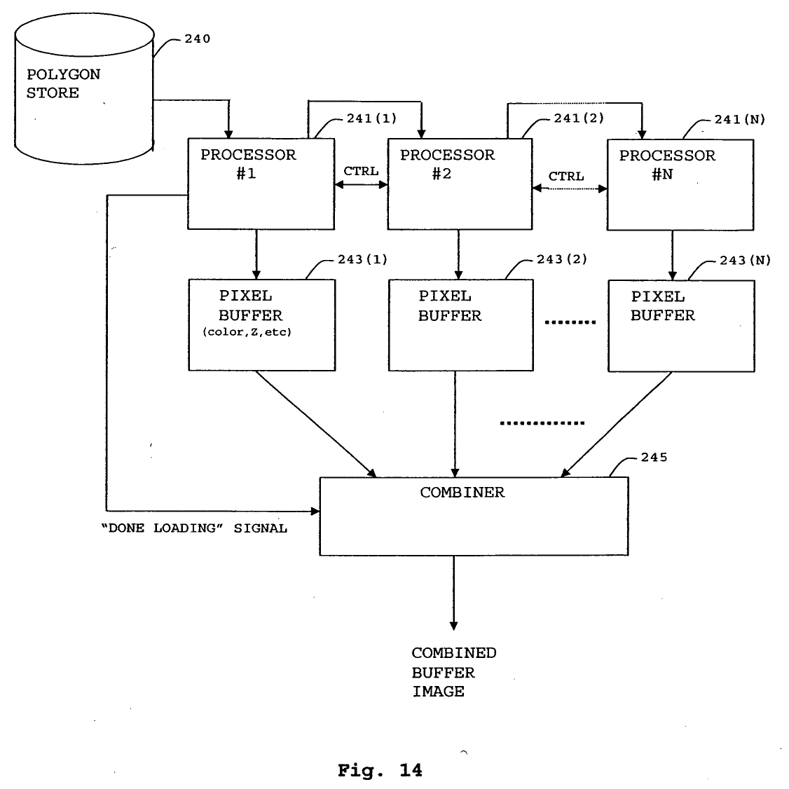

FIG. 14 is a block diagram of a parallel processing system usable to parallel process polygons to render images. As shown there, a first processor 241(1) receives a polygon stream from polygon store 240. Each processor 241 can be similarly programmed such that each processor receives a stream of polygons and retains a “best” fit for each pixel. Except for the final processor 241(N), each processor 241 outputs the nonretained element to the processor to its right.

Each processing cycle, each processor updates its own pixel buffer 243 with color, depth, and other values for the retained element. Once processor 241(1) determines that each polygon has been processed, it issues a done loading signal and a combiner 245 combines contents of the N pixel buffers 243. Because each processor retains its best fit and does not pass it on, the result will naturally be a sorted set of values, with processor 241(1) having the best value, processor 241(2) having the next best value, and so on. In this manner, parallel processing for image rendering can be implemented efficiently and using the multi-level buffering techniques described herein.

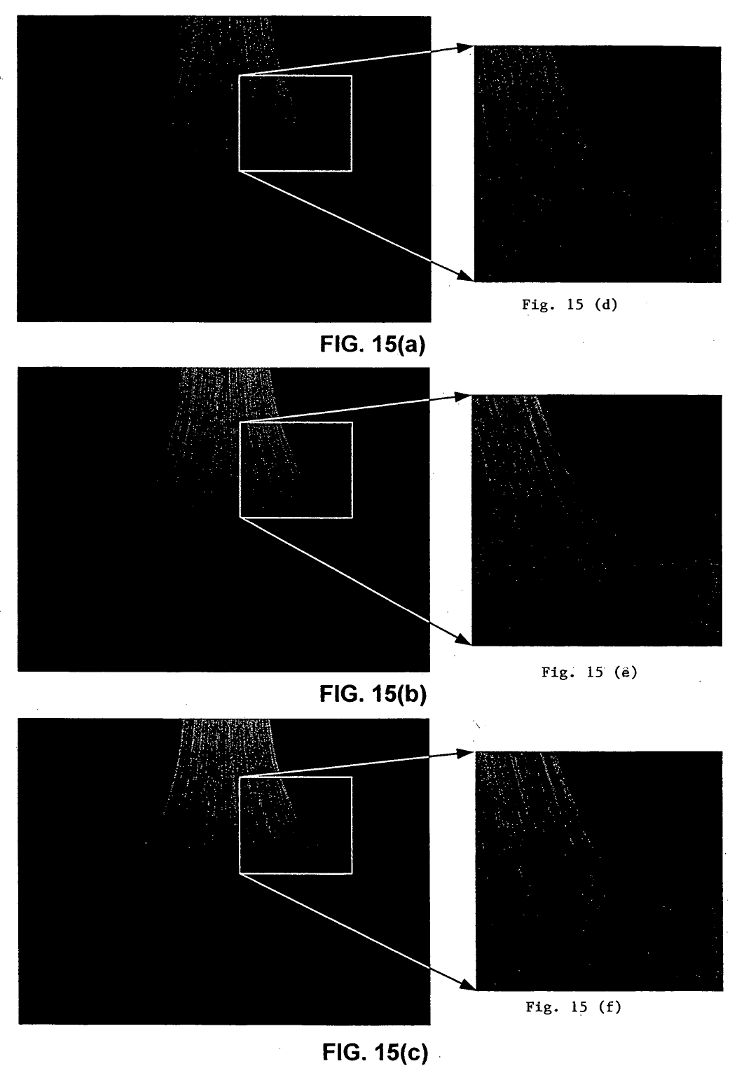

FIG. 15 illustrates effects of image rendering using multiple frame buffers. Each of the images FIGS. 15(a), (b) and (c) were generated from the same set of polygons used to describe a geometric model of many overlapping strands of hair. FIG. 15(a) shows the result of rendering using a single, conventional Z-buffer. FIG. 15(b) shows improved results using two frame buffers (N=2). FIG. 15(c) shows improved results using four frame buffers (N=4). In each of the three figures a blow-up view of a portion of the image is provided (FIGS. 15d-15f).

The above description is illustrative and not restrictive. Many variations of the invention will become apparent to those of skill in the art upon review of this disclosure. The scope of the invention should, therefore, be determined not with reference to the above description, but instead should be determined with reference to the appended claims along with their full scope of equivalents.

1. A video game system including user input devices for obtaining user inputs, at least one processor, and a display output for outputting a video game display, wherein the video game display is at least in part dependent upon the user inputs, the video game system comprising:
a graphics processor for performing graphics operations including at least rendering a pixel array to be used to form the video game display, wherein the pixel array is representative of a modelled collection of elements;
an element memory coupled to the graphics processor for storing data about each element in the collection of elements;
a plurality of pixel buffers coupled to the graphics processor, wherein each pixel buffer of the plurality of pixel buffers comprises storage for pixel data usable for obtaining values for the pixel array, the number of pixel buffers being adjustable;
logic for loading pixel data about elements from the element memory into a selected pixel buffer of the plurality of pixel buffers, wherein the elements are not required to be sorted or selected according to a depth value associated with the elements and wherein the selected pixel buffer is selected pixel-by-pixel based on a depth value for a current element being processed at the corresponding pixels; and
logic for combining pixel data from the plurality of pixel buffers to form pixel values in the pixel array, thereby forming the video game display.

2. The video game system of claim 1, wherein each pixel buffer comprises a frame buffer having storage for a plurality of color values for each pixel in the pixel array and a depth buffer having storage for a depth value for each pixel in the pixel array.

3. The video game system of claim 2, wherein the frame buffer of each pixel buffer further comprises storage for at least one noncolor attribute.

4. The video game system of claim 3, wherein the at least one noncolor attribute comprises one or more of transparency, fog and illumination.

5. The video game system of claim 1, wherein the graphics processor includes an input for receiving an indication of a number of frame buffers to use.

6. The video game system of claim 5, wherein a scene generator determines, for a given scene, the number of frame buffers needed for a suitable rendering of the scene and provides the indication from the determination.

7. An image rendering system comprising:
a graphics processor for performing graphics operations including at least rendering a pixel array to be used to form a display, wherein the pixel array is representative of a modelled collection of elements;
an element memory coupled to the graphics processor for storing data about each element in the collection of elements;
a plurality of pixel buffers coupled to the graphics processor, wherein each pixel buffer of the plurality of pixel buffers comprises storage for pixel data usable for obtaining values for the pixel array, the number of pixel buffers being adjustable;
logic for loading pixel data about elements from the element memory into a selected pixel buffer of the plurality of pixel buffers, wherein the elements are not required to be sorted or selected according to a depth value associated with the elements and wherein the selected pixel buffer is selected pixel-by-pixel based on a depth value for a current element being processed at the corresponding pixels; and
logic for combining pixel data from the plurality of pixel buffers to form pixel values in the pixel array, thereby forming the display.

8. The image rendering system of claim 7, wherein each pixel buffer comprises a frame buffer having storage for a plurality of color values for each pixel in the pixel array and a depth buffer having storage for a depth value for each pixel in the pixel array.

9. The image rendering system of claim 8, wherein the frame buffer of each pixel buffer further comprises storage for at least one noncolor attribute.

10. The image rendering system of claim 9, wherein the at least one noncolor attribute comprises one or more of transparency, fog and illumination.

11. The image rendering system of claim 7, wherein the graphics processor includes an input for receiving an indication of a number of frame buffers to use.

12. The image rendering system of claim 11, wherein a scene generator determines, for a given scene, the number of frame buffers needed for a suitable rendering of the scene and provides the indication from the determination.

13. A signal-bearing medium tangibly embodying a program of machine-readable instructions executable by a digital processing apparatus having stored thereon instructions configured to cause generation of a renderized display, the signal-bearing medium comprising:
program code for processing user inputs to a video game;
program code for generating representations of objects in a scene including at least one object having an appearance or position that is determined based the user inputs;
program code for generating a set of polygons representing the objects in the scene;
program code for loading a sequence of polygons from the set of polygons, such that one or more of the polygons are identified as current polygons and other polygons are previously processed polygons or to be processed polygons and such that polygons are not required to be sorted or selected according to a depth value associated with the polygons;
program code for processing a polygon with respect to pixels of a pixel array, comprising:
a) program code for allocating a plurality of frame buffers wherein the number of frame buffers is adjustable;
b) program code for identifying which of the plurality of frame buffers have cells occupied by data representative of previously processed polygons;
c) program code for identifying an occupied cell; and
d) program code for occupying an unoccupied cell with pixel data corresponding to a current polygon for a corresponding pixel; and
program code for generating a renderized display from contents of the plurality of frame buffers.

14. The signal-bearing medium of claim 13, wherein the program code for occupying an unoccupied cell of a frame buffer with pixel data is program code for occupying an unoccupied cell with pixel data comprising pixel color information, transparency information and a depth information.

15. The signal-bearing medium of claim 13, further comprising program code for loading pixel data about elements from the element memory into a selected pixel buffer of the plurality of pixel buffers, wherein the selected pixel buffer is selected pixel by pixel based on a depth value for a current element being processed at the corresponding pixels; and
program code for combining pixel data from the plurality of pixel buffers to form pixel values in the pixel array, thereby forming the display.

16. The signal-bearing medium of claim 13, wherein the program code for identifying an unoccupied cell identifies an ordering among occupied cells and a current polygon, and swaps occupied cell data and data about a current polygon according to a predetermined criteria.

17. The signal-bearing medium of claim 16, wherein the predetermined criteria is whether the current polygon is closer to a viewpoint then the depth value for the polygons represented by an occupied cell.

18. The signal-bearing medium of claim 17, further comprising program code for executing a video game program including accepting a user input and generating display outputs representative of game results based on the user input.

19. The signal-bearing medium of claim 13, further comprising program code for receiving an indication of a number of frame buffers to use.

20. The signal-bearing medium of claim 19, further comprising program code for determining, for a given scene, the number of frame buffers needed for a suitable rendering of the scene and providing the indication from the determination.
